(19) United States
(12) Patent Application Publication
(10) Pub. No.: US 2004/0019900 A1
(43) Pub. Date: Jan. 29, 2004

(54) Integration platform for interactive communications and management of video on demand services

(76) Inventors: Philip Knightbridge, New Hope, PA (US); Stephen Griffin, Carlsbad, CA (US)

Correspondence Address: PATENTMETRIX, 14252 CULVER DR. BOX 914, IRVINE, CA, 92604, US

(21) Appl. No.: 10/201,564

(22) Filed: Jul. 23, 2002

(51) Int. Cl. G06F 17/60; H04N 7/16; G06F 3/00; H04N 5/445; G06F 13/00

(52) U.S. Cl. 725/23; 725/46; 705/14

(57) ABSTRACT

The present invention to is directed toward an integrated standard platform for the integration of content distributor's back office processes with multiple services from different vendors. A centralized management architecture supporting configuration and accounting management functions for multiple services is provided. The architecture comprises a database for storing configuration, user profile and usage data. The architecture also includes a service and a support gateway to regulate the provisioning, security, policies and operations regarding the content delivery. The centralized architecture has the ability to manipulate data stored in the database for facilitating delivery and control of service provided by the third party vendors. The architecture further includes a package manager module, which allows the content distributor to personalize the available content for an individual user. The campaign manager within the package manager enables the distributor to conduct promotional campaigns before, in-between or after the requested content delivery.

### FIELD OF INVENTION

The present invention relates to a method and system for providing a substantially universal architecture capable of enabling a broad range of interactive communication services, such as interactive television. More specifically, the present invention enables the advanced management of content on demand services by cable companies, satellite broadcasting companies, and content providers.

### BACKGROUND

Interactive television (iTV) combines traditional television broadcasting with interactive features commonly found in conventional personal computers connected to the Internet. Functionally, iTV applications enable users to browse web sites through a television display, access electronic mail, engage in chat room activity, perform banking activities, obtain entertainment on demand, and conduct online commerce, among other activities.

To enable such iTV applications and services, conventional television, satellite, and cable systems must incorporate new technologies and integrate them with existing television broadcast systems. For example, the broadcast content, including text, audio, video, and graphical images, through which users may access various iTV applications, must be appropriately formatted to enable iTV functionality. Content distributors, namely cable systems and satellite broadcasters, need to adopt the appropriate head-end and back-end systems to support such features as 1) interactive program guides (IPGs) which permit customers to select and sort television programming by time, theme, channel, and other criteria, 2) personal video recorders (PVRs) which enable users to record, store, pause, and playback programming using hard-drive storage mechanisms, as opposed to conventional video tape, 3) video on demand (VOD) which enables viewers to order any type of content on demand, such as movies, television shows, special events, sports programs, and other content, and to control its delivery on their receiving devices by pausing, rewinding, or fast-forwarding them, 4) Internet access, 5) email access, 6) chat room and other interactive communication services, and 7) other enhanced TV services, such as the ability to play along with game shows, participate in opinion polls, get up-to-the-minute news and weather, and obtain more information about the television programs and advertisements a user is watching (including how to make a purchase).

Currently, content distributors have existing systems that are responsible for delivering and managing content. To deliver the aforementioned features, new systems must be integrated with these existing systems. For example, a content distributor's access control system, often referred to as a Conditional Access system, must be capable of discerning which user is authorized to access which service and under what circumstances. Additionally, a user's set-top box, which is connected to a user's television and used to access conventional cable broadcasting or satellite broadcasting, must have the appropriate middleware software that is compatible with the iTV applications being deployed at the content distributor's head-end and the appropriate additional software needed to enable the added, operational features.

It is possible to enable some or all of the aforementioned services by contracting with several specialized equipment/service vendors. Some vendors provide the middleware, which operates in the set-top box and governs how external systems interact with the user's television. Some provide video-on-demand servers that, working with the middleware, allow a viewer to select any content and view it on-demand.

However, working with multiple vendors to provide all of these applications, has several disadvantages. Vendor systems may not be able to communicate with the service provider's legacy systems, such as back office systems. Content distributors need those applications to adapt to their existing back-office systems, such as billing, provisioning, marketing, data management, access control, customer support, and operations management systems. Content distributors are currently faced with a multitude of independent applications, each with their own billing or provisioning systems, resulting in the fragmentation of their back-office operations.

Additionally, the inability to easily integrate various iTV applications isolates critical data stored in legacy systems. As a result, interactive service providers are often unable to use new applications with existing databases for advanced marketing and sales purposes. Further, achieving operational scale, by maximizing delivered services while minimizing operational costs, becomes difficult to do when each iTV application represents an island of isolated data and functionality.

Currently, this fragmentation problem is partially addressed through long, complex and expensive integration projects that require the customized integration of applications such as VOD, Internet access, email access, and other applications with the service provider's existing systems. Typically, if there are N vendors, the service provider has to engage in at least N integration projects with its back office system.

Some attempts have been made to address certain difficulties associated with the integration of heterogeneous technologies. For example, U.S. Pat. No. 6,301,568 discloses an integrated service management architecture supporting configuration and accounting management functions for multiple services. The architecture comprises a database for storing configuration and accounting data. The architecture includes at least one service application independent from the database having the ability to manipulate the data stored in the database for facilitating delivery and control of service provided by at least one service application. The architecture further includes a predefined application program interface having a set of communication rules and protocols permitting two-way exchange of information between the database and the at least one service application.

These approaches, however, do not sufficiently address the needs of content distributors. They do not provide a way of integrating key iTV applications, such as VOD, with back-office systems. More specifically, they do not provide content distributors with a holistic solution that makes historical user data accessible to new applications or enables content distributors to customize entertainment packages to a user's viewing habits.

It is therefore desirable to have a method and system that allows for relatively rapid implementation of interactive services, simplified integration with existing services and legacy systems, and increased ability to use historical user data with new services, features and functionalities. More particularly, it is desirable to have methods and systems that allow a service provider to devise, deploy and manage marketing and sales campaigns of video-on-demand service packages, tailored for specific users, using multiple data sources, including historical user data.

### SUMMARY OF THE INVENTION

It is a general object of the present invention to provide an integrated standard platform for the integration of content distributor's back office processes with multiple services from different vendors. Another object of the invention is to provide a standard architecture for personalization of content for an individual subscriber.

In carrying out the above object and other objects, features, and advantages of the present invention, a centralized management architecture supporting configuration and accounting management functions for multiple services is provided. The architecture comprises a database for storing configuration, user profile and usage data. The architecture also includes a service and a support gateway to regulate the provisioning, security, policies and operations regarding the content delivery. The centralized architecture has the ability to manipulate data stored in the database for facilitating delivery and control of service provided by the third party vendors. The architecture further includes a package manager module, which allows the content distributor to personalize the available content for an individual user. The campaign manager within the package manager enables the distributor to conduct promotional campaigns before, in-between or after the requested content delivery.

The above object and other objects, features and advantages of the present invention are readily apparent from the following detailed description of a plurality of embodiments of the invention when taken in connection with the accompanying drawings.

### BRIEF DESCRIPTION OF DRAWINGS

The foregoing and other objects and advantages of the invention will be appreciated more fully from the following further description thereof, with reference to the accompanying drawings wherein;

FIG. 1 is a functional block diagram of a content distribution system;

FIG. 2 is a block diagram of the components of present invention;

FIG. 3 is a more detailed block diagram of a plurality of Third-Party modules;

FIG. 4 is a block diagram of Back office operations modules;

FIG. 5(A) is a block diagram of the delivery modules;

FIG. 5(B) is a more detailed block diagram of the Conditional Access Systems and Set-Top Box;

FIG. 6 is a block diagram showing locally generated content modules;

FIG. 7(A) is a block diagram of one embodiment of an adapter interface used in one embodiment of the content distribution system;

FIG. 7(B) is a block diagram of alternate embodiment of an adapter interface used in one embodiment of the content distribution system;

FIG. 8 is a block diagram depicting the architecture of one embodiment of the centralized management platform;

FIG. 9 is a block diagram of one embodiment of a package manager used within the centralized management platform;

FIG. 10 is a block diagram of a campaign manager used within the package manager; and

FIG. 11 is a schematic flow diagram showing an exemplary flow of data within a video on demand campaign manager.

### THE DETAILED DESCRIPTION

The present invention is directed towards an integrated platform for interactive communications, such as interactive television and the improved management of content on demand, for instance audio/video on demand. Detailed reference will now be made to specific embodiments of the invention. While the invention will be described in conjunction with specific embodiments, the described embodiments are not intended to limit the invention. For instance, the back-office system for processing elements disclosed herein and use of the centralized management platform are not limited in application to managing content on demand services.

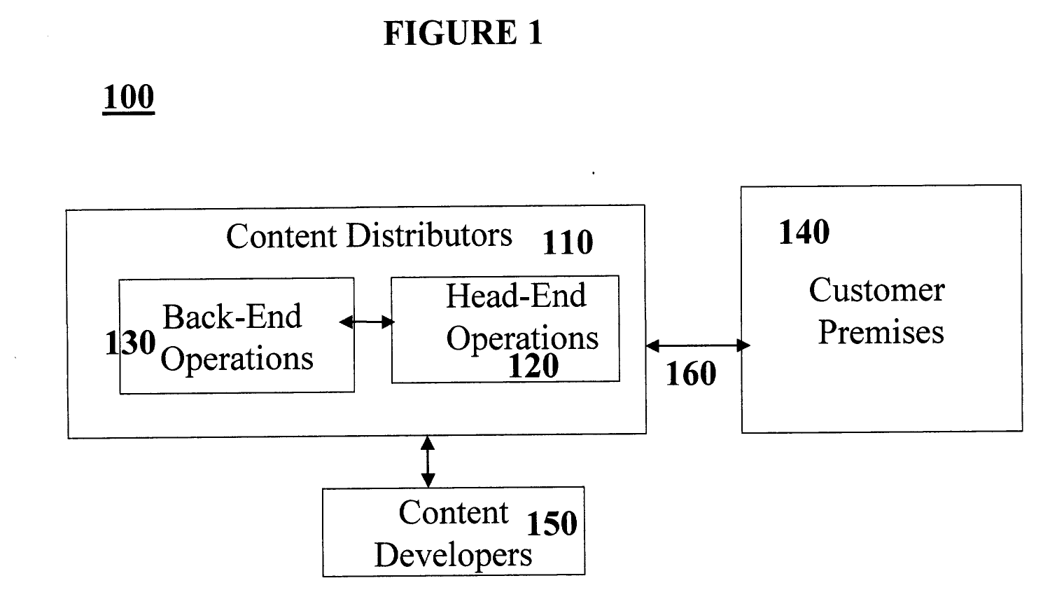

Referring to FIG. 1, a block diagram of a content distribution system 100 is shown. An example of such system is an interactive television system. Content distribution system 100 includes content providers/developers 150, content distributors 110, customer premises equipment 140 and a delivery infrastructure 160. At the broadest level, content distributors 110 operate by integrating a set of back-end operations 130 and head-end operations 120. Typically, content distributors 110 distribute content through a client-server architecture wherein the client device, present in the customer premises 140, communicates with a plurality of servers located in the head end 120. The client device could be any type of transceiver, including a conventional set top box, a set top box combined with a storage device, or a personal video recorder or any other device having a decoder, a buffer for temporary storage of encoded/decoded data, a network interface, and synchronization hardware. The user accesses the content provided by the content distributor 110 through its head-end operations 120 via a graphical user interface displayed on any type of display device, such as a television.

Content providers/developers 150 are responsible for developing content, which may include text, audio, photos, videos, or any other type of information or data and for delivering that content, in transmissible form, to content distributors 110. The users, referred to as subscribers or customers interchangeably hereinafter, request a content distributor for a service who then delivers the requested service to the subscribers over a prescribed delivery infrastructure 160. The delivery infrastructure 160 may include coax networks, optical fiber networks, hybrid coax-fiber networks, satellite, standard or high-speed telephone line services, or wireless networks. The content distributors 110 may be local network television stations, cable television providers, and/or satellite TV providers. Apart from the aforementioned client device such as a set top box, enabling the user to access the available services, the customer premises equipment 140 also includes a plurality of software applications, including applications enabling specific interactive television functionalities, an operating system, and a platform, or middleware application, that enables the seamless operation of the plurality of application-specific programs and the operating system.

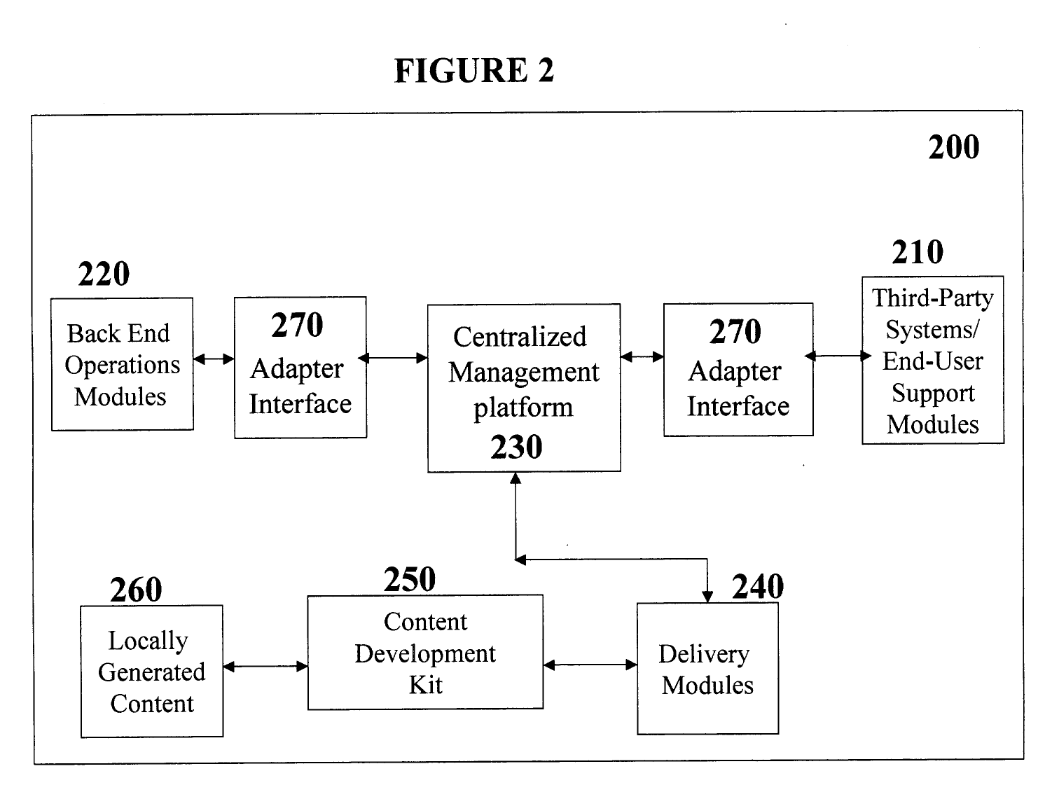

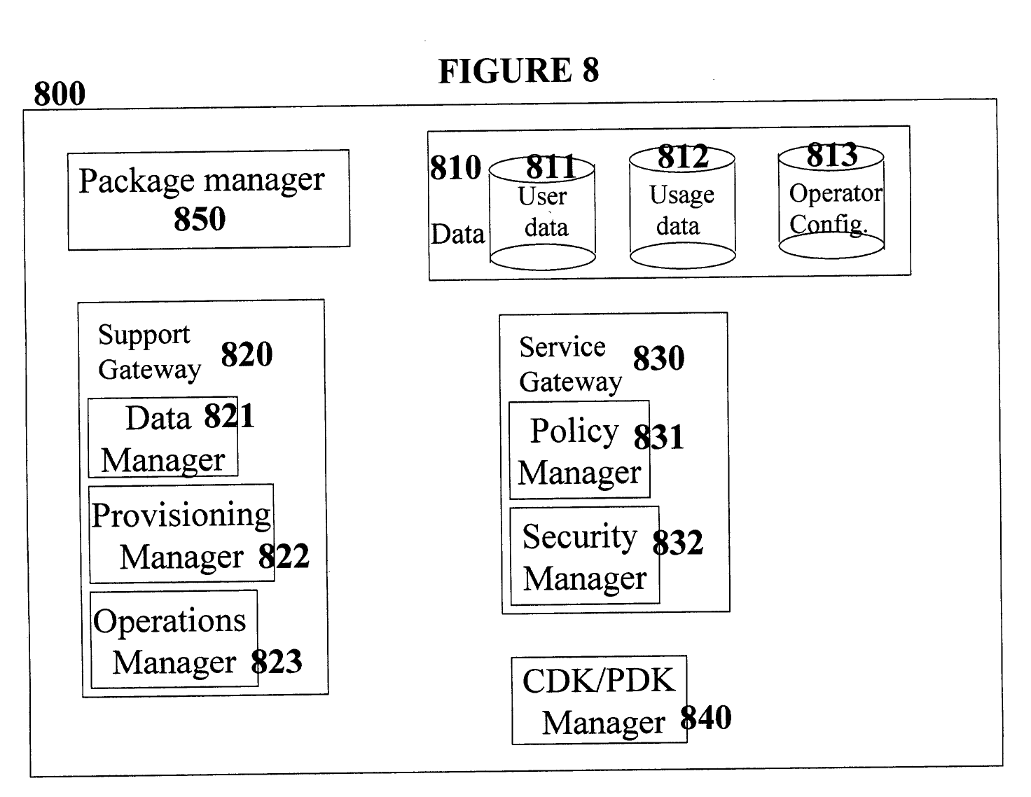

A preferred structure of the content distribution system 200 is shown in FIG. 2. The centralized management platform architecture 230 enables third party services 210, provided by different vendors, to communicate with the standard back office operations of a content distributor, shown as element 130 in FIG. 1, through interfacing adapters 270. The centralized management platform 230 of current invention, detailed further in FIG. 8, supports the operation of a plurality of interactive television services. However, the platform 230 is not restricted only to the third party services 210 described herein and is designed to support the addition of new services and service platforms.

Third Party Services

Third party services enable a user to communicate interactively over the content distribution system. For instance, such services include electronic mail, video on demand, instant messaging, electronic wallet, on line shopping, personalized video recording, advertising, searching, calendars, electronic program guides and many more similar services.

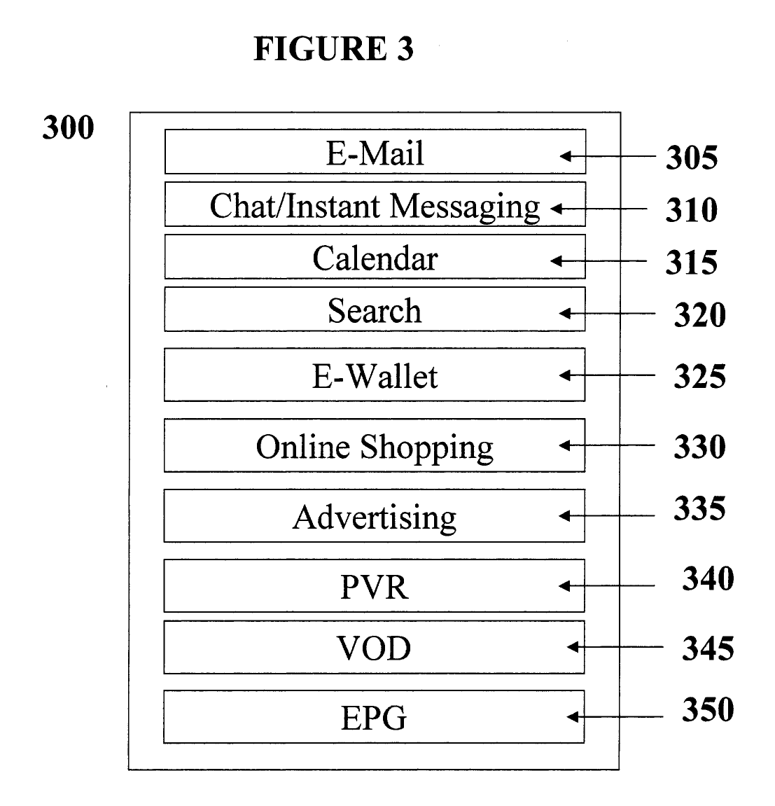

Referring now to FIG. 3, electronic mail 305 is a service that can be deployed over a client-server architecture. Every client is assigned an identifier, which can be used to request the server to send and receive messages to and from other clients accessible over the cable network and networks with which the cable network is in communication. The system can work as a conventional email system where a plurality of servers maintain a database of users' identification and demographic profiles and the client has software that users can use to input messages, access messages, and manage their email. The mechanism includes a set of mail protocols followed by the clients and the servers, such as the Simple Mail Transfer Protocol (SMTP) and Post Office Protocol (POP). Another protocol used to send attached documents and files with the messages is the Multipurpose Internet Mail Extension (MIME).

Interactive chat or instant messaging service 310 allows a subscriber, through a client device, to type in messages in a dialogue box displayed on the display device. The messages are then transmitted to a plurality of instant messaging servers located at the content distributor's head end. The servers also transmit messages to the client device that are sent by other users over the cable network or networks in communication therewith. The user is therefore able to send notes back and forth using the interactive chat/instant messaging service 310.

Another third party service includes calendar functionality 315 where users can store important events, for instance holidays, date of births and other occasions over a remote server and can retrieve those events, or be reminded of those events, through pop-up dialog boxes. The calendar could be displayed using a graphical user interface that displays a chart showing the months, weeks and days of the year on the user's display device with the stored events appropriately indicated.

Another feature supported by current invention is search 320 comprising of search engines which are software systems residing at the content distributor's head end, or accessible by the head end, and enable the user to search for the information he requires through an Internet service or through the access of the Internet via the cable head end. While the user is accessing the Internet through the client device attached to his television, he can type in a plurality of search parameters, such as words to be searched, into an entry area, such as a space provided on the graphical user interface of his display device. The client device transmits this request to servers at the head end to conduct a search for all the content pertaining to that particular search construct. In response to the user's request, the search engine in the head end servers identifies a list of related content and, preferably, links to such content.

In another service, an electronic wallet 325 enables subscribers to conduct secure banking transactions at their own premises. For instance, the subscribers can use their credit cards to complete transactions and can lock and unlock their cards for security. The service also includes servers residing at the head end, which store the passwords and the encryption keys along with the user's identification to ensure security.

E-commerce functionality 330 can also be integrated into the present system. An e-commerce system permits a user, through a user interface, to identify, select, and purchase a desired product or service by providing the user with a data input mechanism, such as a keyboard, mouse, or remote control that interfaces with a set top box to input alphanumeric characters, and routes that data through secure e-commerce enabled servers. The servers are capable of securely accepting purchaser data, including personal, credit card, and other information, and remitting that data to the requisite authorization services to obtain approval for a user's purchase.

The current invention also enables the content distributors to conduct advertising campaigns 335. The advertising may be delivered in any form, including a web site style banner advertisement or an audio-video advertisement capable of accepting user responses. Content distributors, using servers located at the head end, could insert advertisements into programs being sent to users. The insertion can be done either by incorporating a static link on an area in the page being displayed on the screen or as call-to-action, i.e. as a blinking icon. These exemplary modes provide the subscriber with the ability to access an advertiser. Advertising using an interactive communication network helps customers find out more information about a product and also to purchase it at a convenient location.

Personal video recording 340 allows subscribers to access content, for instance television programming, with the ability to control content playback, such as by pausing the program and by reviewing it from the point the program was paused at, automatic programming and recording of shows that the consumer prefers, and skipping over periods of the program that have commercials or other unwanted segments. The system operates with a built-in storage device in the client device for storing the programs, for instance, a hard disk drive or any other storage media or by storing programs on a server at the head-end. Exemplary personal video recorders are designed by companies such as TiVo, Inc. and manufactured by companies such as Sony Corporation and U.S. Phillips, Inc.

Video on demand (VOD) 345 enables the subscribers to select a particular content type from a list of available content stored on a plurality of servers at the head-end to be viewed by the subscribers. The selected content type could be television programs, movies, events, sporting events, music or some other form of stored media or real-time encoded broadcast. The VOD servers send the requested content to the subscriber over a delivery mechanism such as cable, satellite, or other transmission infrastructure. The client device may have some storage media in which the delivered content can be stored and viewed by the users. The user may also be provided with the transport control functions such as controlling the delivered video. This may include pause, fast forward, and so forth. The transport control functions are typically supported at the headend where the content is located/stored.

An onscreen guide 350, referred to as an electronic program guide (EPG) or interactive program guide (IPG), helps users choose and/or view content by listing programs, channels, pay per view events, and other shows available at particular times. In an EPG, a menu of available programs is displayed on the display device. The subscriber sends a request through the input device of his system to select a particular program out of that list and view the requested content as delivered by the head end of the content distribution network. EPG software located on the client device may also be responsible for keeping track of the content that is frequently watched by the subscribers, restricting user's access to content, and/or offering a search engine that can search for types of content the subscriber might be interested in.

Back End Operations

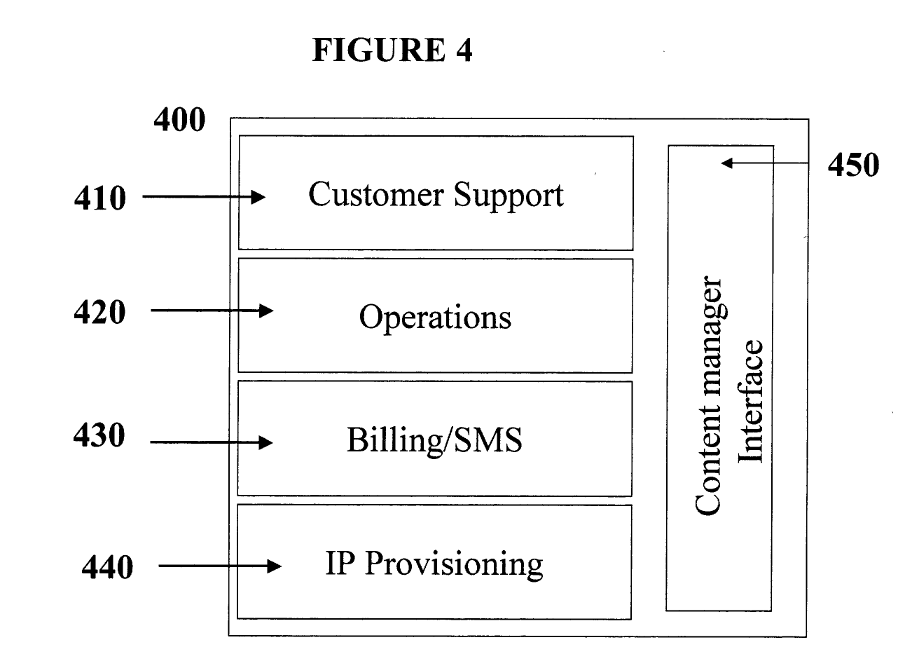

Referring now to FIG. 4, shown is the back-end operations module 400, consisting of subscriber management activities. The subscriber management operations include processes like billing 430, customer support systems 410, service provisioning 440, and network management and interfacing 450. The aforementioned back office system provides a support and a transaction control system to the content distributors. The system 400 enables the content distributor to do a plurality of subscriber management activities, including, for instance, create, modify, and delete information about the customer, equipment, and services, establish customer accounts, process orders and miscellaneous changes, and perform credits and bill inquiry.

The operational module 400 includes a customer support service module 410 to facilitate an interactive communication between subscribers and content distributors. The service allows the distributor to converse with a subscriber to address the problems and queries of a subscriber. The service includes a server at the system head end, which provides services like storing a database of frequently asked questions and their corresponding solutions and other similar data. The subscriber either browses the available content through the client device attached to his television or he can interact directly with the content distributor's support personnel at the head end using interactive communication services like instant messaging, telephone and other similar mechanisms allowing interactivity.

Billing 430 includes a network resource meter, which keeps track of the usage of interactive services. Each user is assigned a unique account number. The user's demographic profile along with his network resource usage is stored in a database on a server residing at the system head end. The billing operation access this database and utilizes the network resource usage information gathered over a predetermined period of time to calculate the amount of money to be charged from each individual customer. Using this billing module, the content distributor can generate bills for individual users using the user's unique account number and usage history. At the end of the billing process, the system updates the current account status for a user.

Provisioning 440 is another back office operation supported by current invention, which enables communication among various network elements. Provisioning enables the content distributor to ensure the activation of system components, for example the physical network and its support systems, which facilitate the delivery of interactive services to a subscriber. The mechanism comprises of the activation and configuration of the subscriber's access device, using transfer protocols such as file transfer protocol (FTP) to download the service level parameters, such as a modem's speed range, dynamically assigning an IP address to the customer premises device and activating and configuring the back-end operations support system (OSS) and the business support system for account management and billing and enabling other network elements shown in FIG. 2.

The content manager interface 450 supports the communication between the abovementioned back office operations of the content distribution system and the centralized management platform, shown as 230 in FIG. 2. The interface is a programming interface, consisting of the set of statements, functions, options, and other ways of expressing program instructions and data. The interface provides the physical and logical arrangement supporting the attachment of the centralized management platform to the standard back office system of the content distributor using a predetermined set of rules.

Content Delivery

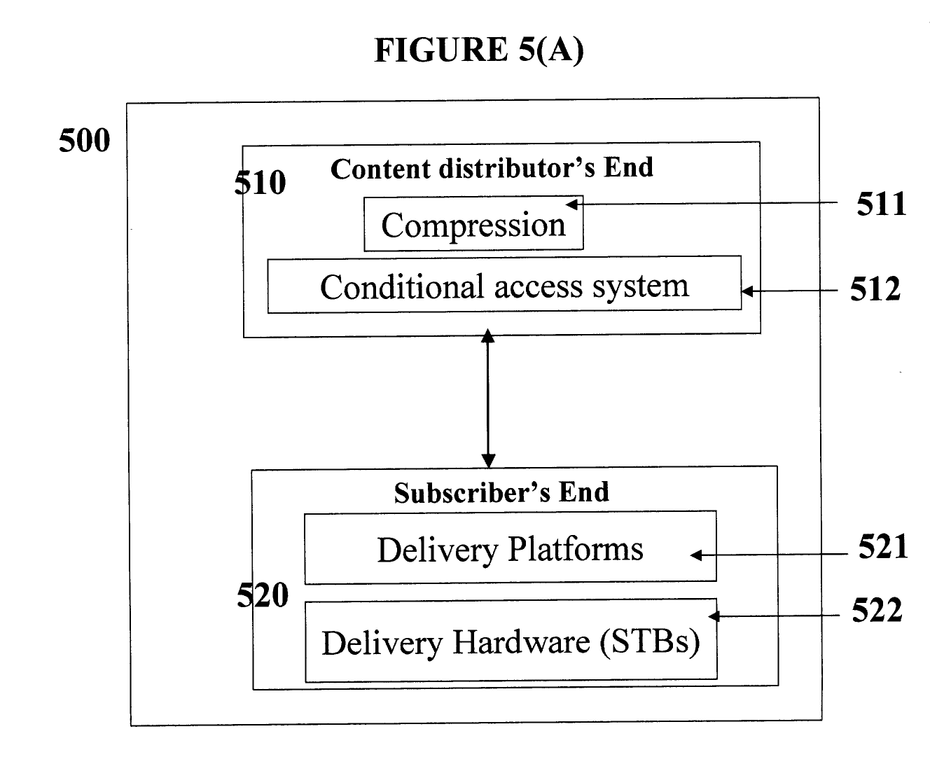

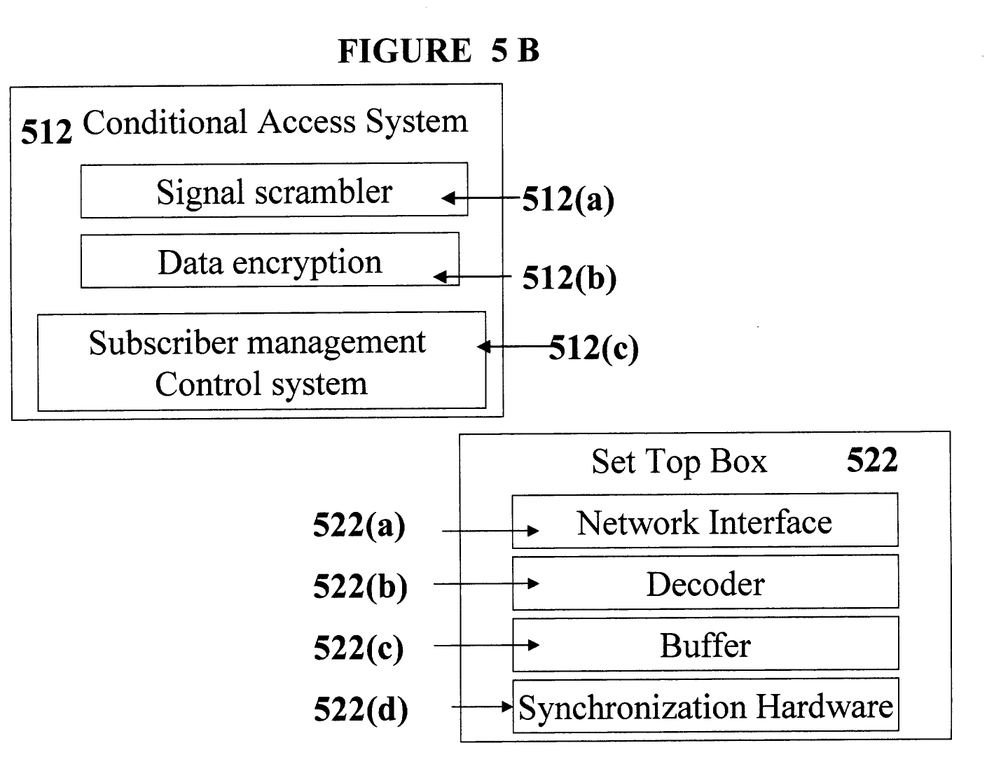

Referring to FIG. 5A, content delivery modules 500 are located at the head end of the content distribution network and at the customer's premises. The delivery modules at the content distributor's end 510 include devices such as analog to digital converters [not shown], data compressors 511, the conditional access systems 512 and other data processors. The delivery modules at subscriber's end 520 consist of delivery hardware, such as the set top box 522 and the software platforms 521.

Digital compression 511 of data that is being sent to the viewer, or being sent by the viewer back to the service provider, is accomplished by using digital technologies that convert analog signals to digital bits and store them in a highly compressed format. Compression is achieved by any type of conventional means. A typical compression standard is MPEG-2. The content distributor's Conditional Access System 512 is a control system that allows only those subscribers who have paid, or have agreed to pay, to access certain services. Shown in FIG. 5B, the access control system 512 primarily includes signal scrambling, 512(a), encryption 512(b) using electronic “keys” required by the subscribers to access protected content, and a subscriber management control system 512(c) that insures those who have bought the scrambled programming are able to receive and watch it.

Referring back to FIG. 5A, the delivery modules at the subscriber's end 520 include a service access client device like a set top box 522 and the underlying software platform 521 that enables the user to access the available services. Set-top boxes (STB) act as a gateway between the receiving system, such as a television, PC, or PC-TV, and the delivery infrastructure, such as the telephone, satellite or cable feed. The STB receives encoded and/or compressed digital signals from the signal source, e.g. satellite, TV station, cable network and other similar sources, and decodes and/or decompresses those signals, converting them into analog signals displayable on conventional displays.

The subscriber sends his requests to the STB by use of an interactive input device like a remote control {keypad} or keyboard. The set top box transmits these commands to the head end of the network typically through a back channel. Resident on STBs are applications specific to third party services, such as Internet access, web browsers, e-mail messaging, and electronic program guides (EPGs). With additional hardware, conventional STBs can function as a storage device, CD ROM player, or DVD player. The set top boxes typically have on-screen user interfaces that can be seen on the display device and interacted with through the use of a hand-held interactive keypad.

As shown in FIG. 5(B), the set top box has a network interface 522(a) to allow the user to receive data from the server and send data back to the server, in a manner that the server can receive and intelligently process it; a decoder 522(b) which decodes/decompresses the received content which is typically in an encoded/compressed format in order to save network resources like storage space and system bandwidth; a buffer 522(c) which temporarily stores content in order to ensure a continuous and consistent content delivery; and synchronization hardware 522(d) enabling the synchronization of different components of content such as audio and video. The delivery platform [not shown] is the underlying system and standards that enable interactivity between the content providers and the subscribers. It also includes the operating system sitting on the set top box, which is used to access the content. Another component of the platform is the middleware software that enables distinct applications and the operating system to work together seamlessly.

Local Content

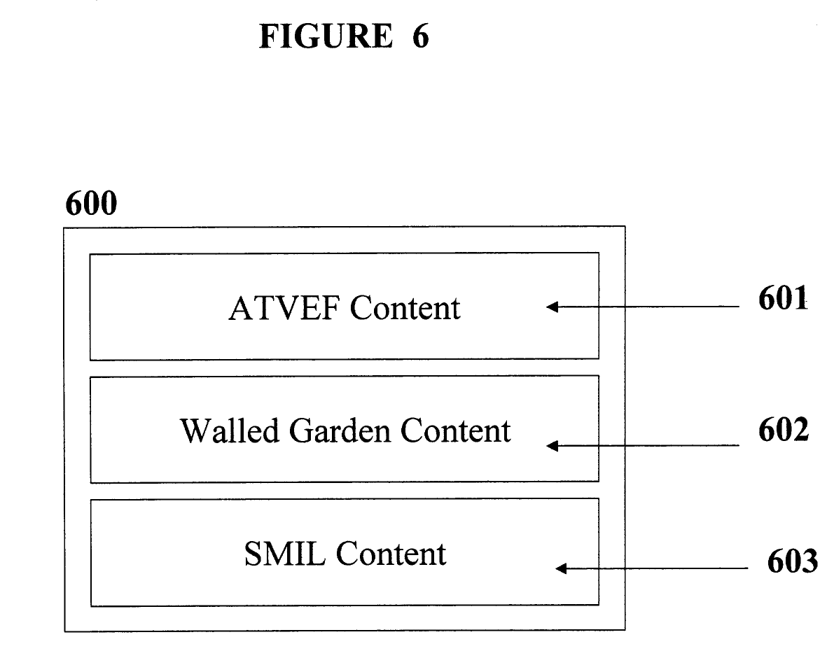

Rather than depend on accessing content from the Internet, content distributors may choose to present a limited amount of content, hosted and controlled by the content distributors. Shown in FIG. 6 is a module enabling a system for delivering locally generated and maintained content. Locally generated content module 600 provides users with locally generated content at fast speeds.

The locally generated content may include walled garden content, ATVEF content and all other types of content formats like SMIL (synchronized multimedia integration language), flash based and the like. ATVEF content, shown as 601 in FIG. 6, is based upon the Advanced Television Enhancement Forum (ATVEF) standard which includes creating enhanced, interactive television content and delivering that content to a range of television, set-top, and PC-based receivers. ATVEF content defines the standards used to create enhanced content that can be delivered over a variety of mediums, including analog and digital television broadcasts, and a variety of networks, including terrestrial broadcast, cable, and satellite. ATVEF content is developed and located locally and is delivered over the broadcast content distributor's network. The content is then either cached to a disk or it may reside on the Internet or any other public network, or on distributor's private network.

The aforesaid specification also defines the mechanism for the delivery of content from the broadcaster to the receiver and informing the receiver about the enhancements of content. The latter task is accomplished with triggers. Triggers are mechanisms used to alert receivers to incoming content enhancements. Among other information, every trigger contains a standard Universal Resource Locator (URL) that defines the location of the enhanced content. The triggers also contain a human-readable description of the content, for instance, “Press Browse for more information about this show . . . ” that can be directly displayed on the receiver's display. Triggers also contain other information like expiration information to provide the receiver contextual information about how long the enhancement should be offered to the viewer, and error correction mechanisms like a checksum to ensure integrity of the delivered information. ATVEF content generated or hosted locally by the content distributor allows the viewer to make a spontaneous purchaser view personalized content using a plurality of servers that is under the control of the content distributors.

A walled garden, shown as 602 in FIG. 6, provides a browsing environment that controls the access of users to content that is either controlled by or authorized by the content distributor. This is used by content distributors to force the user to navigate to pre-designated content. For instance, the user is restricted to specific areas of the Internet, such as restricting children's access to pornography, or directed to pay for content prior to being able to access it. The basic method for creating a walled garden includes creating a series of web pages, which are viewed on a television with a set top box, and navigated to with a remote control. The system presents a menu on the display device similar to a program guide from which the user selects the content designed for TV viewing and not linked to the larger Internet.

SMIL (Synchronized Multimedia Integration Language) content 603 is a format that defines and synchronizes multimedia content elements (video, sound, still images) for presentation and interaction. SMIL is an XML (Extensible Mark-Up Language) based language that essentially groups together content files in an order that the user would like them to appear and combines them into a single stream.

Adapter Interfaces

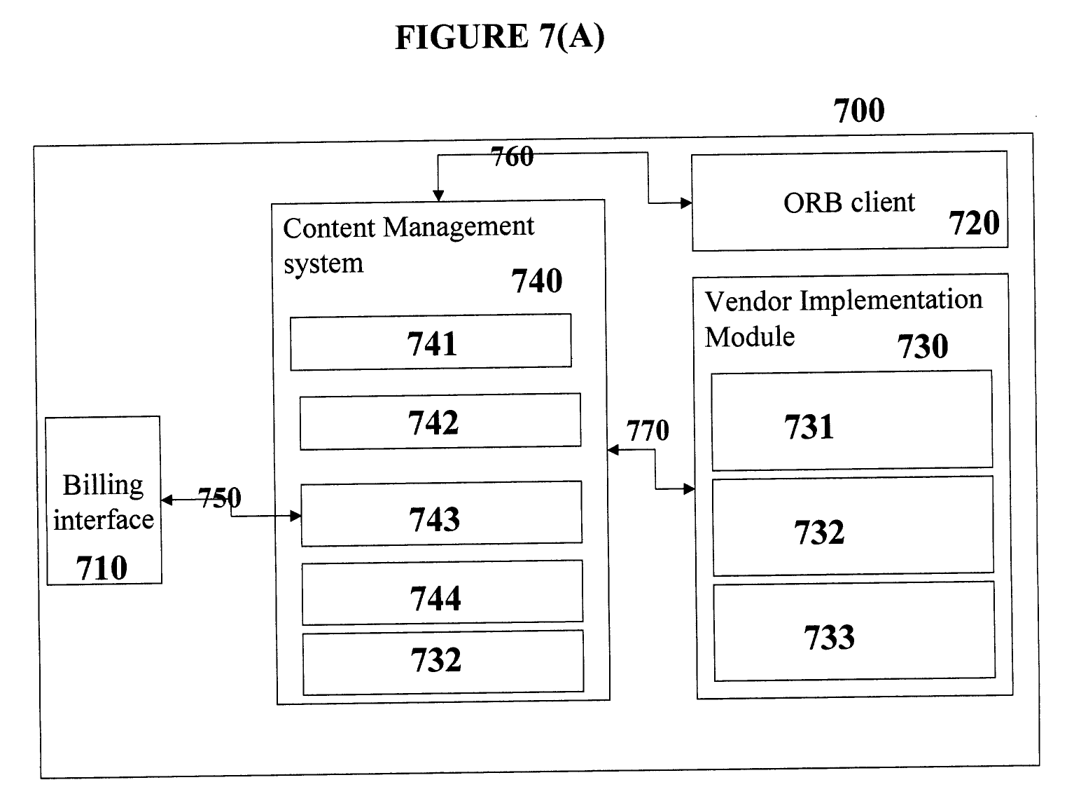

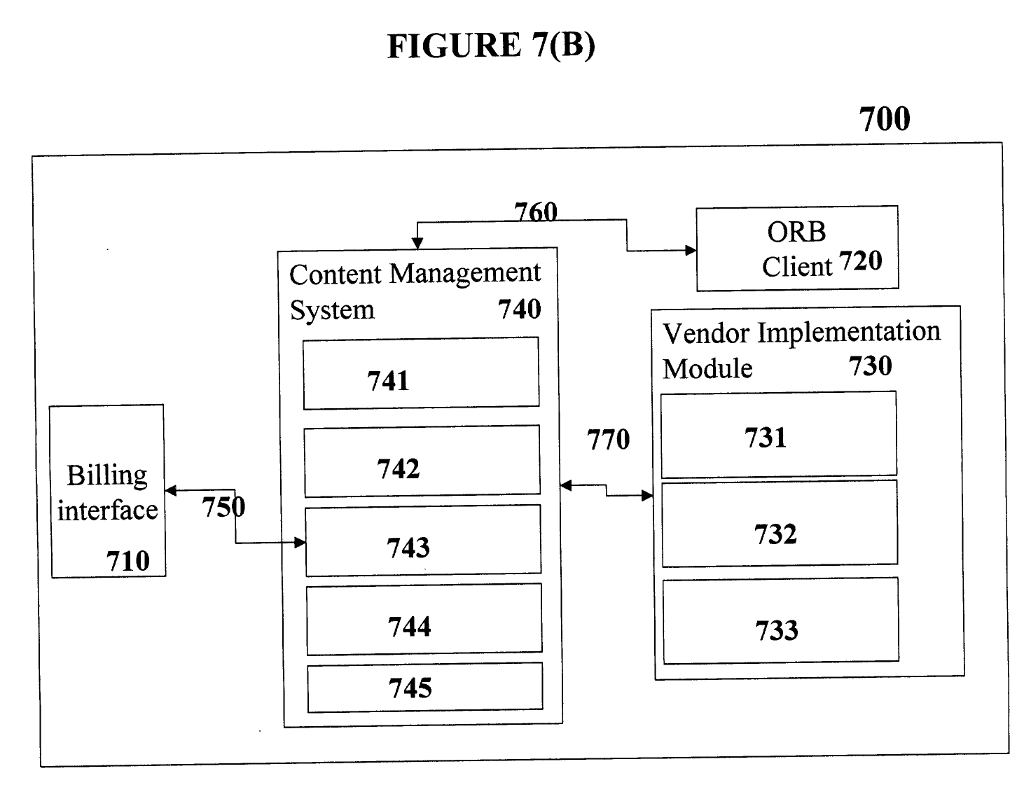

FIG. 7 shows one of the preferred specifications of the adapter interfaces shown as 270 in FIG. 2. The adapters 270 provide a software interface between an application and an integration server. The interfacing adapter 700 in FIG. 7, generates events and interfaces to a plurality of interactive services. The adapter is composed of a design-time component [not shown], which enables metadata browsing and definitions of application views, events, and other similar services and another run-time component [not shown], which at runtime handles the generation of events and the invocation of system-level functions in response to requests by the application. The adapter interface shown here can be a service adapter or an event adapter. The following description gives some of the possible embodiments of adapter interfaces. While the invention will be described in conjunction with specific embodiments, the functionality of these can be extended to include all plausible protocols and pertinent content formats.

Service adapters receive a request document from a client device and invoke a specific function in the underlying enterprise information system (EIS). The request can be made in any of the platform independent languages, for instance, extensible mark up language (XML) or some other similar language. The functioning of a service adapter includes: receiving service requests from a client device as input; transforming the request document into the EIS-specific format; invoking the underlying function in the EIS and wait for its response; and transforming the response from the EIS-specific data format to the same format in which the request was made.

Event adapters are designed to propagate information from an EIS into the application integration environment. They respond to “events” that occur inside the running EIS and extract data about the event from the EIS into the adapter; transform event data from the EIS specific format to another format document that conforms to the application format; and propagate the event into the application integration environment that delivers it to one or more client devices.

The content management system (CMS) 740 provides the content distributors a plurality of tools to enable several iTV applications. The CMS includes a system for managing content, subscriber's demographic profile, transaction and usage analysis, billing, order fulfillment and other services. It includes a central command and control system, a platform for integration with customer support, a billing object model, data management and reporting module and an object request broker (ORB) module, discussed in further details below.

Central command and control 741 in FIGS. 7(A) and 7(B) is the central system of the CMS 740 in FIG. 7. The control is responsible for regulating other component modules that perform various functions across the system. It also controls the communication of CMS with other modules like vendor implementation 730, ORB client 720 and the billing interface 710 in FIG. 7(A)

Shown as 742 is an integration software platform that integrates the user with the customer care server lying at the back end of the content distribution system. It streamlines and standardizes the service methods and procedures. The billing object module 743 initiates a billing event as soon as an application is requested by the client device (ORB client) 720 in FIG. 7(A). The module is in direct communication with the client device, billing server at the back end, and with the vendor implementation module 730.

The data management and reporting module 744 in the current embodiment of the adapter manages, reports and captures contact and user participation information and communicates it to the content distributor's back end. It allows the content distributors to deliver consistent access of third party services by controlling the bandwidth consumption of individuals and groups, defining and managing service level agreements for service management.

In one embodiment, CMS 740 is implemented using an object request broker 732 (ORB) in FIG. 7(A). An object request broker provides a directory of services and helps establish connections between clients and these services. As a client requests for a particular service, the ORB locates the service at a remote service system, activates that service and establishes the connection between the client and the remote service system to enable the communication between them. Any ORB providing platform interoperability can be deployed by the system of current invention, for instance CORBA (common object request broker architecture), JacORB (ORB for JAVA) and others.

The ORB 732 is middleware that handles the communication details between distributed objects. One example of the ORB that may be used is the CORBA (Common Object Request Broker Architecture) ORB, which is a common protocol to provide the content distributors interoperability among a plurality of vendors. It offers a plurality of services, for instance naming, event management and others. Naming assigns a name to the applications or objects in a distributed environment, thereby allowing these applications to be recognized by each other. The ORB 732 in the preferred embodiment maintains a set of bindings, which relate names to objects. Clients use this naming service to locate objects by name. This naming service allows applications to store and access references to ORB objects. The service also enables ORB objects to register and be located by name. This includes a set of unique names for which the name servers can be either located at the same place (as shown here) or can be distributed across the network and work in conjunction with each other. The other service provided by the ORB, the event service, registers each request made by the client as an event and keeps track of the proceedings pertaining to that event, for instance, service delivery, billing, among others.

The vendor implementation module 730 is provided by the content developer who specifies the functional attributes of the application or the service provided. The module essentially comprises of an ORB object model 731 based on a set of specifications. For instance, the CORBA object model as determined by the OMG (Object Management Group) specifications may be used here. The OMG specifications treat an object as an instance of a ‘type’. ‘Type’ groups entities have similar architectural features. The object model 731 enables the interactions between clients and the remote object implementations. A request made by the client consists of a target object, the operation requested and any parameters therein. A service is provided as a result of the request. Object model 731 provides a standard programming interface that can be used in a wide variety of environments and applications.

The vendor implementation module also consists of an ORB 732 in FIG. 7(A) which is the counterpart of the object request broker, within the CMS 740 of FIG. 7(A). With similar architecture and functioning like the aforementioned ORB 732, it is responsible for the communication between the vendor implementation module 730 and the CMS 740.

The vendor specific functionality module 733 in FIGS. 7(A) and 7(B) presents substantially all functional attributes of that particular vendor's application. The information comprising the attributes includes all the features and services the application offers to the subscriber, the billing mechanism for that application, and how the content distributor can integrate that service into his current system of services.

The billing object model 743 of CMS 740 communicates with this vendor specific functionality module through an Inter-ORB Protocol, for instance Internet Inter-ORB Protocol (IIOP) 770, shown in FIG. 7(A). IIOP is a protocol that makes it possible for distributed programs written in different programming languages to communicate over the Internet.

The client 720 is any ORB client that is able to access an ORB object by its name or address. It offers a simple interface to the user where the user selects an operation, enters all parameters and as a result, a plurality of options are displayed. The ORB client allows the user to access arbitrary services by placing a request at runtime. The request may be made using an Interface Definition Language (IDL) protocol 760. The IDL protocol is a language that lets a program or object written in one language communicate with another program written in an unknown language. Typically, the IDL compiler is responsible for storing the interface descriptions into an interface repository. The ORB client obtains the necessary ‘type’ information, i.e. the type of an operation, from an interface repository (not shown). The interface repository is a component of the ORB that provides storage and management of interface descriptions and thereby makes them accessible to clients.

Another component of the current embodiment of adapter interface 700 is the billing interface 710. This interface provides a billing system with open database architecture. The interface allows the content distributors to use their standard back office billing operation with the new applications. It loads user demographic profile from CMS 740, handles special edits, such as setting the user's billing code and manages the data in the existing legacy system of the content distributor and decides what data to import. The billing interface 710 may communicate with the CMS through RPC (remote procedure call) and IDL 760. RPC is a protocol that one program can use to request a service from another program located in some other computer in a network without understanding the network details or formats.

Another preferred embodiment of adapters is shown in FIG. 7(B). This embodiment is similar to abovementioned one except that, here, within the CMS 740, instead of ORB 732 a remote method invocation (RMI) to IIOP bean 745 can be used. The term “bean” refers to a reusable software component that can be used across numerous software applications. For instance, one bean used in the current embodiment is Java Bean, which is a platform-neutral architecture for the Java application environment.

The RMI to IIOP bean 745 extends the RMI programming model by providing the ability for clients to access RMI remote objects using IIOP. It connects with the clients using the standardized IIOP protocol. The client could be a JAVA or a CORBA client. RMI is a method in which objects on different computers can interact in a distributed network. RMI is the Java version of an RPC, but with the ability to pass one or more objects along with the request.

Operation of Adapter Interfaces

In one operational embodiment, the abovementioned adapters function in the following manner. A plurality of interactive services provided by the third party vendors have different functionalities and implementations. These implementations and data formats need to be compatible with the back office processes of the content distributors. Thus the adapter interfaces referred by the numeral 700 in FIGS. 7(A) and 7(B) perform the mapping of vendor specific applications to standard operations of the back end. Before provisioning services to users, each vendor supplies an implementation module along with the application it offers, the module containing the attributes and functional specifications of that particular application. The client may request for a service to the CMS using IDL, or any other similar protocol defining the interface. In response to this request, the CMS communicates with the vendor implementation module to find out the functional attributes of that service. For this communication, the CMS uses a protocol, which enables the interaction of two different ORBs, for instance, IIOP and the like. Based upon the information gathered from vendor implementation module, the CMS builds a billing object model, which then communicates with the operator's back end billing operations through the billing interface.

The Centralized Management Platform

Referring to FIG. 8, shown one embodiment 800 of the centralized management platform 230 of FIG. 2. More components may be added or removed enabling the content distributors to use the platform for other advanced services in future. The module stores and processes data received by abovementioned adapter interfaces on both sides. The platform 800 further includes sub modules like, a data module 810, a package manager module 850, service 830 and support 820 gateways and a CDK/PDK manager 840. The data module 810 further consists of user data 811, usage data 812 and the operator configuration data 813. The user data module 811 refers to the subscriber information kept by the content distributor to conduct various back end operations like billing, provisioning and other processes. The user data may include a user's demographic profile information such as his name, age, sex, occupation and his address and other such information. The usage data module 812 keeps track of usage of the network resources. This may include the type of content watched and the time for which it is watched, among other data. Preferably the stored data 812 also give an account of the user's viewing habits such as which user likes what type of content and how frequently he likes to view that content.

The operator configuration module 813 includes a set of properties or attributes of the developer's service configuration. This configuration tells the complete functioning of operators' network and back office operations in general. The properties [not shown] currently supported comprise the data source string (for opening a connection to the underlying database), the bandwidth available and the data transfer rate. Prior to any content delivery and reception, the centralized management platform takes as input the contracts between the distributor and originator and stores this information to this operation configuration module 813.

The support gateway 820 within the current embodiment of the centralized management platform 800 includes a set of manager sub modules like a data manager 821, a provisioning manager 822 and an operations manager 823.The data manager 821 is a program, which allows the aforesaid centralized management platform 800 to process and manipulate the user and the usage data in a logical manner. Data manager 821 reads and writes the data coming from and going to the adapter interfaces. It maps the data received from the adapter to another format used by aforementioned architecture and stores and processes the same. The data manager 821 is responsible for a plurality of control and management functions, such as appending data, deriving data, filling the missing content in the received data, filtering the received data and passing the remaining data to storage, merging data, sorting data and other similar operations.

The provisioning manager 822 enables the automation of the interactive services offered by content distributors. The provisioning manager is also responsible for ensuring the correct functioning of the content distribution system and its components.

The operations manager 823 within the support gateway is an administrative tool for collecting diagnostic data, storing that information in a database, and generating automated responses (according to predetermined rules) to events occurring within the platform 800. It has three components: the agent, the consolidator, and the data access server (DAS) [all three not shown]. The agent is a service that monitors the system 800, collects information and sends it to the consolidator for processing. The agent also sends a signal depicting its own status to the consolidator. Consolidator is responsible for collecting information from the agent and sending it to the DAS, which is the component that the operations manager uses to store collected information, rules, and configuration data. As such, this component handles the database input/output traffic to and from consolidator.

The service gateway 830 within the system 800 comprises of a policy manager 831 and a security manager 832. The policy manager 831 is a program for managing the local policies and procedures of the centralized system 800. The program is responsible for setting up the rules and policies for the communication among and access across various components of the aforesaid architecture. It is also responsible for governing the priority of and the bandwidth available to various components of the content distribution system 100. The policy manager 831 allows the content distributors to regulate and manage the protocols followed by the traffic of the aforesaid system. It also does error detection. For instance, it generates an exception or an interrupting signal at the violation of policies. This manager supervises the transactions between content developer and the content distributor; and between content distributor and the users. This includes regulating and ensuring the fulfillment of the terms and conditions imposed by the developers. For this the module makes use of the contract information stored inside the operator configuration module 813. For instance, these contract terms may include the fraction of the total revenues generated by the content distributor from the users, shared with the content developer in turn. The terms may also include the conditions determining the types of content, which can be packaged together for any user. These terms and conditions may reside on a separate database [not shown] at the system head end.

The second sub module within the service gateway 830 is the security manager module 832 which is a software program allowing the content developers to manage the information of the entire content distribution system such as user identifications, authorizations and security settings across a plurality of databases and environments. The key functionalities of this security manager 832 include providing distributed security administration across multiple databases, consolidating information detailing user access capabilities across multiple databases and other similar activities like provision and maintenance of passwords for the users. Security manager 832 serves as the definition and enforcement of the database security policies that govern user access. User profile, password policy, privilege allotment, role and object grants, as well as application specific registrations are managed via this single entity. Security manager 832 enables the content distributors to store the authority private keys and also maintains a database of users' private key histories for recovery purposes in the event that users lose access to their keys.

The content development or product development kits (CDK/PDK) manager 840 regulates the functioning of these kits. The content distributors use these managers to develop content within their own local network, running from the network head end to the customer premises. The locally generated content can be the aforementioned walled garden content, the ATVEF content or any other similar type of content.

In addition to all of the aforementioned components, the centralized platform also has a package manager 850 detailed below.

The Package Manager

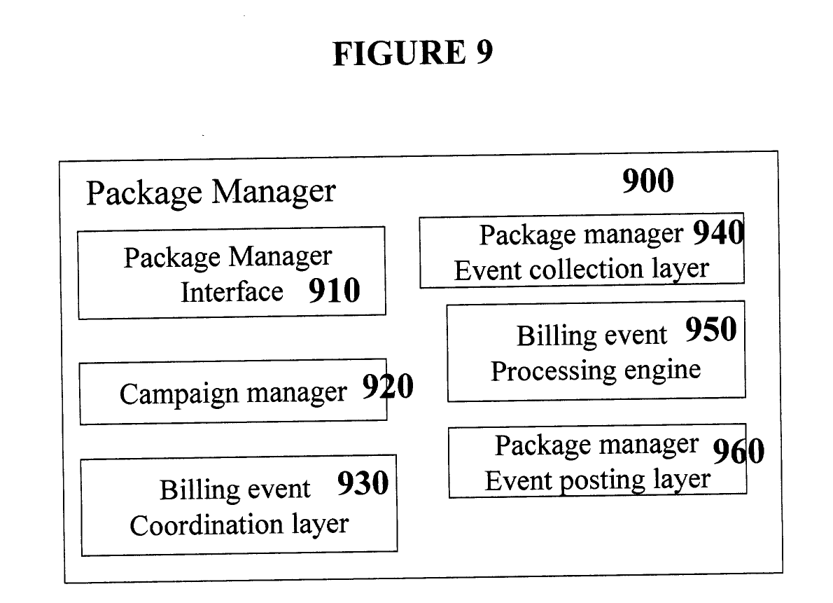

Referring to FIG. 9, the package manager 900 further comprises of a package manager interface 910, a campaign manager 920, a set of software layers including billing event coordination layer 930, package manager event collection layer 940 and the package manager event-processing layer 960 and a billing event-processing engine 950. The module 900 provides an improvement over currently existing interactive services, typically proprietary video on demand systems. The centralized management platform is flexible and allows addition and elimination of similar modules for future applications. The package manager module 900 discloses a preferred embodiment of a typical content manager, which allows the content distributors to present the users with additional offers and packages while users are accessing service or content.

Content distributors create packages of content locally and can deliver them to their subscribers/users with the help of this package manager module 900. Content distributors provide a standard package of services provided to all subscribers within their geographical service area. It consists of a number of programming services, for instance, local and regional stations, provincial educational services, community channels, as well as various optional services. Optional services may be offered for an additional fee over and above the price of basic service. They are generally grouped into various packages or tiers, according to strict ‘linkage’ rules, which govern the ratio of certain broadcasting sources to other sources. Discretionary services can be either scrambled (like pay TV) or unscrambled.

The package manager interface 910 acts as physical and logical arrangement supporting the attachment of the packages created by the content distributor and the campaign manager 920. It is a programming interface, consisting of the set of statements, functions, options, and other ways of expressing program instructions and data provided by a program or language for a programmer to use. The interface 910 uses inter-process protocols like the simple object access protocol (SOAP) to conduct the communication between the locally generated content packages and the campaign manager 920. The created packages are broken down into objects, which are then accessed by this interface and forwarded further to the campaign manager 920 as detailed further.

The package manager event collection layer 940 registers any request made by the client as an event. It receives the request messages from the adapter interfaces and converts them to a standard language, for instance, XML. This XML request message generates an event in the event collection layers with the help of some billing event generators [not shown]. This layer works in conjunction with the event manager within the campaign manager 920 discussed herein.

The billing event coordination layer 930 provides references between package manager 900 and the content distributor's back office billing and support system. This layer is in direct communication with the billing structure of a particular distributor and provides that information to the campaign manager 920 to make proper revenue calculations.

The campaign manager 920, which is the central component of the package manager 900, stores the package specifications and the corresponding policies and pricing plans. The campaign manager is in communication with the data module of the centralized platform to gather the users' account reference information. This is further discussed below.

The information derived from the aforementioned package manager interface 910, the billing event coordination layer 930, the event collection layer 940, and the data module 810 are fed to the campaign manager which then communicates this information to a billing event processing engine 950. This billing engine 950 also receives information from staging for multi-part events [not shown], which allows the rating and management of multiple billing events.

The billing event processing engine 950 records events, aggregates them according to the packaging rules as defined within the campaign manager, and subsequently rates/bills the aggregations. The billing event-processing engine compiles, generates and summarizes the elements of a consolidated bill. These may include recurring charges, usage charges, one-time charges, credits and adjustments for any service and line of business. The engine also performs package-specific tax calculations and applies hierarchy-based aggregation and discounting rules. The engine allows the content distributors to produce a single bill for customers subscribing to different services, such as local, long distance, mobile and IP.

The bill thus generated by the billing event processing engine is then posted back to the billing systems, shown as 430 FIG. 4, of the distributor's back office through the package manager event posting layer 960.

The Campaign Manager

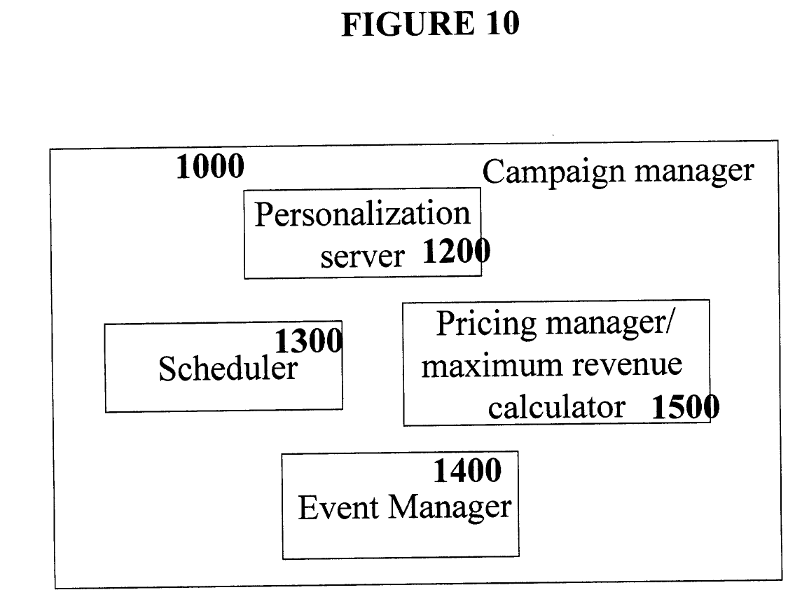

Referring now to FIG. 10, the campaign manager module 900 comprises of a personalization server 1200 enabling the personalization of the content as per subscriber's viewing habits, a scheduler 1300 responsible for scheduling of content, an event manager 1400 controlling the processes such as campaign generation and delivery, and a pricing manager or a maximum revenue calculator 1500.

Personalization server 1200, allows the content distributors to build a pool of content for a specific subscriber, as per his own choices. To achieve that objective the server carries out a sequence of comparisons and selections. As discussed earlier, the data module 810, maintained by the content distributor, stores the user data 811, which includes user's demographic profile and his viewing habits. The aforesaid user data may include name, age, sex, occupation, residence etc. The usage data module 812 keeps track of the usage of network resources and the amount and type of the content viewed by each individual user. The vendor of the third party services also typically maintains a statistical relationship between the content type and the corresponding category of users viewing that type of content.

The personalization server 1200 within the campaign manager combines the two sets of the abovementioned statistics (from the content distributors and the third party services providers) to generate a pool of content specific to a user. The server thus personalizes and stores this created pool of content, and provides them to scheduler 1300 and event manager 1400 (detailed herein below) thereby enabling the user to receive only the desired content. The scheduler module 1300 requests content developers to deliver specified content at specified instants of time for a specific user. The scheduler communicates with the pool of tailored content stored in the personalization server to select the time and the type of content to be delivered to a particular user.

In a preferred embodiment, personalized content delivery is divided into a plurality of stages. For instance, based upon an individual's taste, the scheduler may request a content storage and transmission device to transmit a movie preview, then to transmit a video requested by the user, and, subsequently, to add advertisements offering discount packages for future content viewing. The content distributor decides the order of the requested content and the accompanying content for the marketing campaign as per the calculations made by the personalization server. The packages offered to the subscribers may include a discount on a movie's price, the price of several combined movies, or future movies in exchange for a current purchase. It also allows the users to accept the offers instantly and delivers the requested content.

The event manager 1400 is responsible for the management of events occurring inside the campaign manager 920. As the subscriber requests content from the aforementioned pool of tailored content, an event is generated. The event manager 1400 registers each content delivery as a billable event. The content developer's content servers, for instance video on demand servers communicate with this event manager whenever any content is transmitted to the user. The event manager captures all of the selection information by the user, records an event, keeps track of when and what type of content is presented to the user, or if the user declines the package. The event manager module also generates the appropriate billing information accordingly and sends it to the content distributor to make him able to bill the customer accordingly.

The price calculation or amount of money charged from a subscriber for a particular content delivery is done by a pricing manager/revenue calculator module 1500. The pricing manager 1500 enables the content distributors to establish rules-based pricing of content for a specific period of time. A plurality of pricing adjustments can be set up dynamically, depending on the changing needs of a distributor and his content offers. Taking into account the current usage pattern and the contract information stored within the operator configuration module 813, it performs an assessment (including calculation as well as estimation) of the potential revenues generated when a user accesses a content item or a package of content items and uses this information to direct the promoting of additional content to the user. The module 1500 communicates with other components of campaign manager and also to the policy manager to calculate the billable amount for a specific content delivery. The content distributors may include discounts based on, for instance, membership, usage frequency, or any other data, while calculating the price for a package. This module 1500 also enables the content distributors to plan promotional pricing on individual products or entire categories of content in advance. The pricing manager/maximum revenue calculator 1500 calculates the allowed number of customers for a content distributor and the corresponding revenue generated out of them.

In a preferred embodiment, a network accessible interface allows content distributors to associate various pricing levels with various content accessed at different times and in different combinations. The network accessible interface could permit for the manual input of pricing levels, defined in a database format, by 1) content type and/or specific content names, 2) viewing time, and 3) order combination, i.e. permitting the discount ordering of two very popular movies, provided two less popular movies are included in the order. This data could also be automatically communicated from content providers who, in association with content distributors, may provide for specific royalty structures for certain content types, specific content, viewing times, and order combinations. Having royalty terms integrated with pricing data and related to content packaging structures permits content distributors to dynamically calculate the value of a particular content package offer. In operation, content distributors can create a set of packages that will satisfy the tastes of individual users while driving maximum revenue to the content distributor.

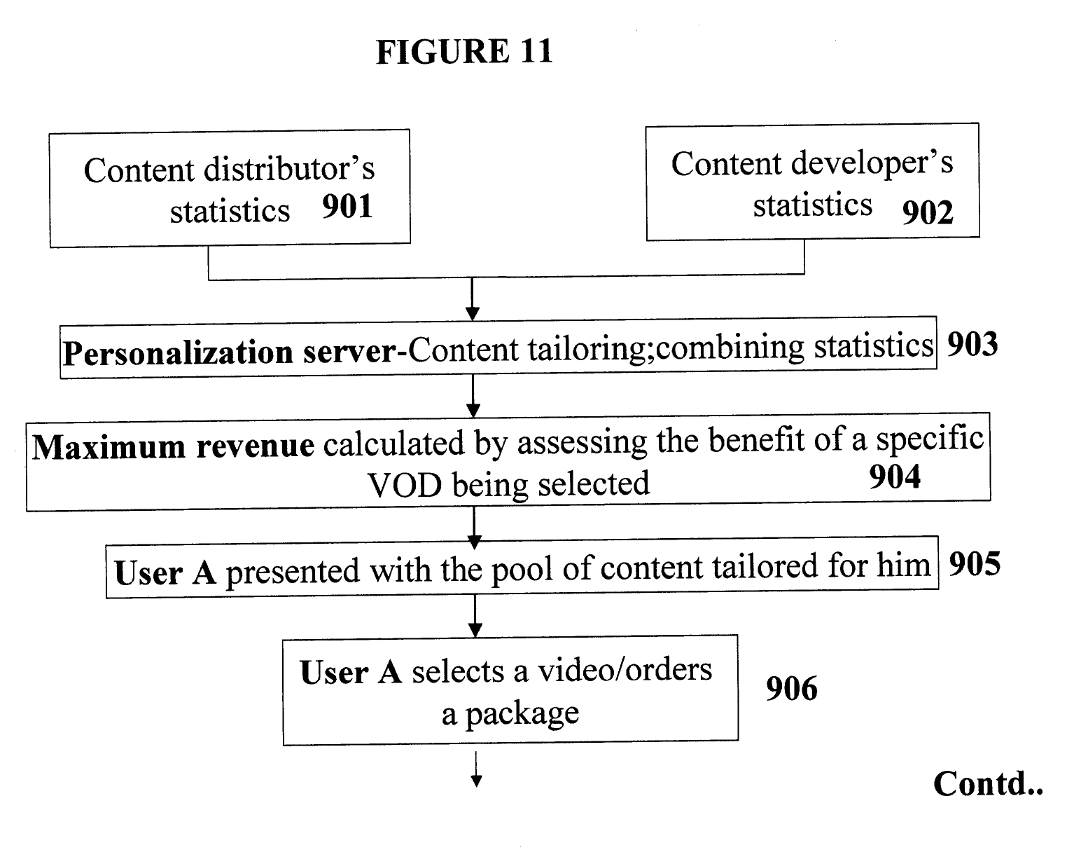

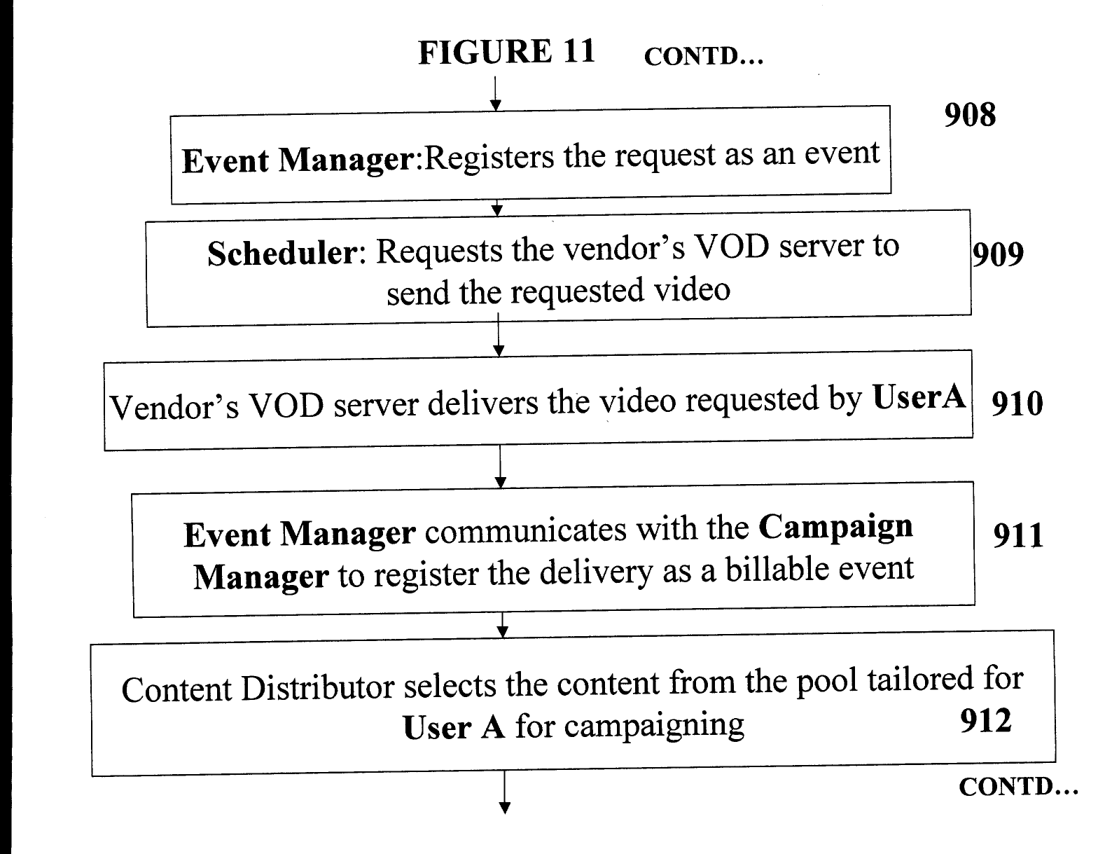

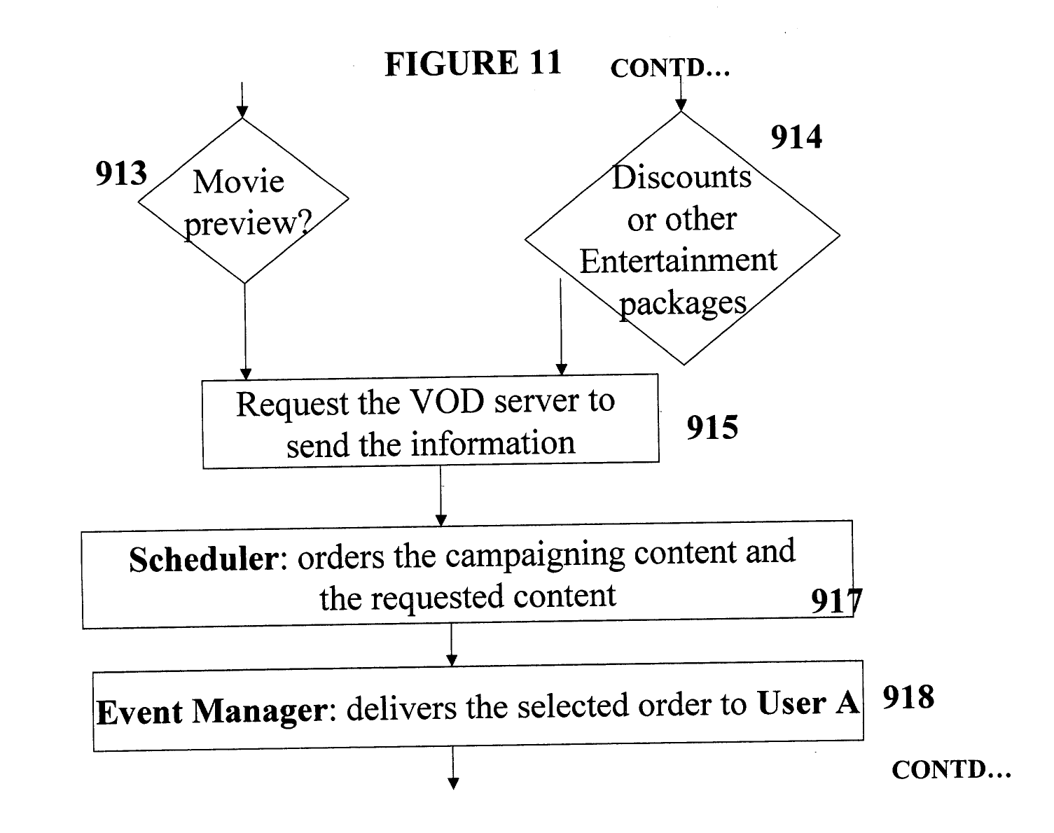

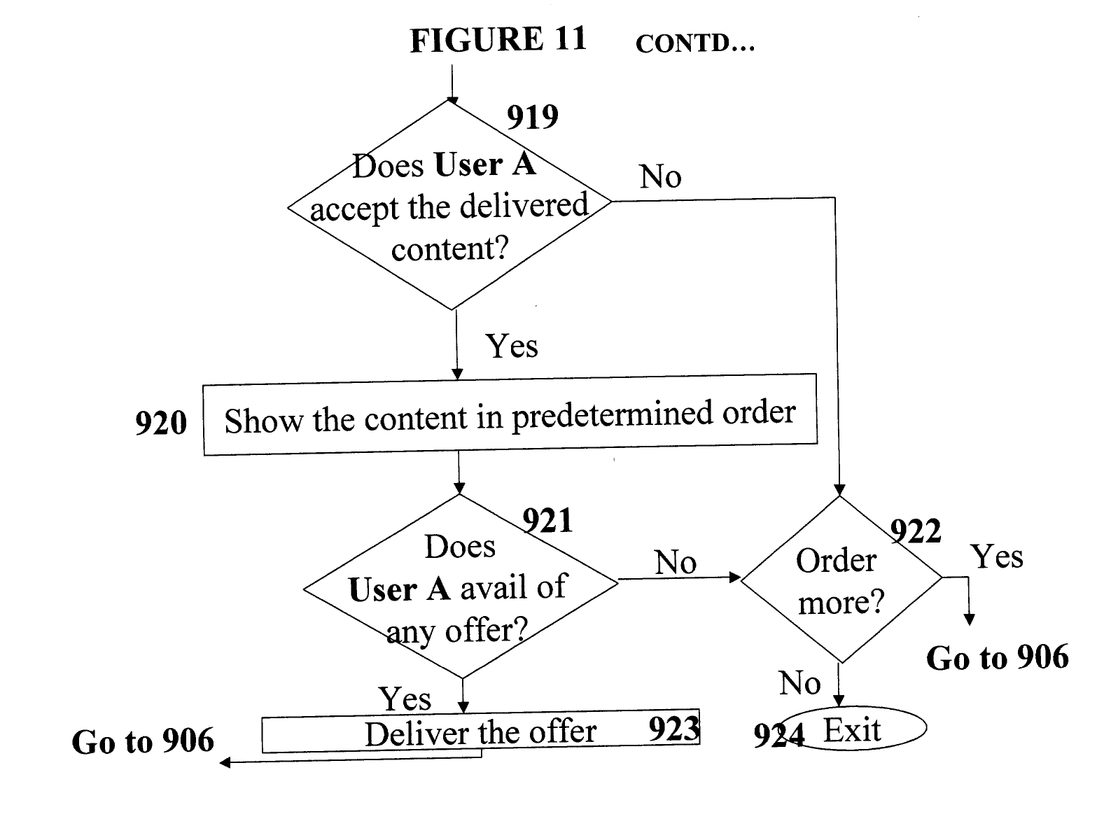

FIG. 11 is the schematic flowchart representation of the flow of data enabling the aforementioned package offers and content campaigns. As discussed above, the personalization server combines 903 the users' demographic data 901 as well as usage data 902 collected by the content developers and the distributors, to determine what the user may like to watch. This personalization process 903 is primarily defined by the generation of user profiles from raw user data, the profiles being indicative of the user and his or her historical viewing, and a comparison of that user profile with content profiles.

In a preferred embodiment, the user profiles, obtained by accessing databases of subscriber data, are defined by a plurality of ratings of specific criteria, such as comedies, actor names, and other various criteria. Using historical viewing patterns gathered from usage data, the ratings of specific criteria can be specified for each user. Those ratings are then compared to content profiles to identify content items that have attributes, such as the actors or content type, which match the user's positively rated criteria. In another preferred embodiment, the demographic profile data of the user could be compared to a demographic profile associated with specific pieces of content. Content providers are often aware of what type of user, defined by a specific demographic profile, may be most interested in content produced by the content provider. The content provider could associate that demographic profile with other general descriptors of their content prior to transmitting that content to the content distributor. The personalization server can then compare the user's demographic profile with the demographic profile associated with the content to identify content to recommend to a user.

In either case, the personalization server develops 903 a pool of content, available as programming options in a plurality of databases, tailored for a particular subscriber. The pricing manager or the maximum revenue calculator can then be used to identify 904 the combination of content items that will optimize the revenue for the content distributor in light of various royalty agreements. The revenue calculation can also be conducted to optimize revenue for a content distributor, a content provider, or both a content distributor and content provider. The pricing manager may therefore select one or more items of content, identified in the course of step 903, to offer as a consolidated package to the user, shown as step 905.

Using his or her client device, the user selects 906 some or all of the identified content offers to view. Upon doing so, the event manager registers 908 this request as an event. The scheduler, upon receiving a message from the event manager, requests 909 the head end server, e.g. the VOD server, to send the desired content. The VOD server delivers 910 the requested content and the event manager communicates with the campaign manager interface of the content distributor's back office to further communicate with the billing operation.

With the personalized content pool created, the content distributor can add 912 advertisements for content and other package offers to include in the scheduled transmission, either before, during, or after, of the content ordered by the user, including a movie preview 913 and discounts for other entertainment packages 914. A VOD server is requested to send information 915 to the scheduler, which then orders 917 the campaigning content and the requested content. The event manager delivers 918 the selected order to the user who is asked 919 to accept the content. If the user accepts 919 the content, the content is shown 920 in a predetermined order. If not, the user is asked 922 whether he wants to order more; if yes, the user is presented 906 with a set of personalization options from which the user is prompted to select a package, and if not, the system exits 924. If the user is shown the content, the user is prompted to accept an offer. If the user avails 921 of an offer, the offer is delivered by returning 923 to previously described process.

The described embodiments are preferred approaches for delivering interactive services. There can be many other ways of applying the current invention, such as for the management of package offers for a plurality of other interactive TV applications discussed herein. The deployed concept of taking the core functionality of a vendor's system, making it flexible by integrating it into the aforementioned centralized management platform, and using a personalization engine can be extended to other service areas such as providing Internet access. Therefore, while described in association with a specific application, the embodiments discussed herein are meant to only be examples of what the methods and systems of the present invention can effectuate.

What is claimed is:

1. A system for delivering content to a subscriber wherein the content includes programs and offers for purchasing programs, comprising:
a plurality of databases to store subscriber data;
a plurality of databases to store programming options;
a personalization server to identify a first set of programming to offer the subscriber wherein at least one criteria used to identify the first set of programming is subscriber data and wherein the first set of programming is identified from said programming options; and
a processor for implementing a computer program that identifies a second set of programming wherein said second set is a subset of the first set and the second set is identified by determining a combination of programming that, if purchased, generates greater revenue relative to other programming combinations.

2. The system of claim 1 further comprising a subscriber device for receiving an offer to purchase the second set of programming.

3. The system of claim 1 wherein the determination of whether a combination of programming, if purchased, generates greater revenue relative to other programming combinations is conducted from the perspective of a content distributor.

4. The system of claim 1 wherein the determination of whether a combination of programming, if purchased, generates greater revenue relative to other programming combinations is conducted from the perspective of a content provider.

5. The system of claim 1 wherein the determination of whether a combination of programming, if purchased, generates greater revenue relative to other programming combinations is conducted from the perspective of both a content provider and content distributor.

6. A system for delivering an offer to a subscriber wherein the offer is generated after a request for content by the subscriber, comprising:
a plurality of databases to store data wherein said data includes the request for content by the subscriber;
a plurality of databases to store programming options;
a personalization server to identify a first set of programming to offer the subscriber wherein at least one criteria used to identify the first set of programming is the content request and wherein the first set of programming is identified from said programming options; and
a processor for implementing a computer program that identifies a second set of programming wherein said second set is a subset of the first set and the second set is identified by determining a combination of programming that, if purchased, generates greater revenue relative to other programming combinations.

7. A system for delivering offers for purchasing content from a set of content choices to a subscriber, comprising a processor implementing a computer program that identifies a set of content wherein said set of content is a subset of the content choices and is identified by determining a combination of content that, if purchased, generate greater revenue to a content distributor relative to other content combinations.

8. A system providing configuration and accounting management functions for a plurality of interactive services including interactive television services, the system comprising:
at least one storage device for storing configuration, usage and accounting data;
a provisioning module implemented in a computer for provisioning content over a content distribution network;
a service gateway implemented in a computer for enforcing the policies and security protocols controlling a subscriber's access of content; and
a package manager for packaging offers of content, wherein the package manager enables the creation of content package offers personalized to an individual subscriber;

9. The system of claim 8 further comprising a processor implementing a computer program that identifies the content in said content package offers wherein the content is a subset of a plurality of content choices and is identified by determining a combination of content choices that, if purchased, generate greater revenue relative to other combinations of content choices.

10. A computer implemented architecture supporting configuration and accounting management functions for a plurality of interactive services including interactive television services provided by multiple vendors, the system comprising:
at least one database, the database storing operator configuration data and user and usage accounting data relating to said interactive services;
a package manager for packaging offers of content, wherein the package manager enables the creation of content package offers personalized to an individual subscriber;
a support gateway to regulate content delivery;
a service gateway to control security and policies related to content delivery; and
a content development kit manager;

11. The system of claim 10 wherein the architecture communicates with a plurality of adapter interfaces using a set of rules permitting communication of configuration and accounting data between a plurality of support systems and a plurality of interactive service applications.

12. The system of claim 10 wherein the package manager further comprises:
a package manager interface;
a package manager event layer;
a billing event processing engine; and
a campaign manager, wherein the campaign manager further comprises a personalization server, a scheduler, an event manager; and a pricing manager.

13. A method for delivering content to a subscriber wherein the content includes programs and offers for purchasing programs, comprising the steps of:
storing subscriber data;
storing a plurality of programming choices;
identifying a first set of programming to offer the subscriber wherein at least one criteria used to identify the first set of programming is subscriber data and wherein the first set of programming is identified from said programming choices; and
identifying a second set of programming wherein said second set is a subset of the first set and the second set is identified by determining a combination of programming that, if purchased, generates greater revenue relative to other programming combinations.

14. The method of claim 13 further comprising the step of a subscriber receiving an offer to purchase the second set of programming.

15. The method of claim 13 wherein the determination of whether a combination of programming, if purchased, generates greater revenue relative to other programming combinations is conducted from the perspective of a content distributor.

16. A method for conducting promotional campaigns of content packages created according to a subscriber's preferences, comprising the steps of:
collecting subscriber data, including demographic profile and viewing habit information;
retrieving at least one content profile wherein said content profile describes a plurality of content attributes;
comparing the subscriber data with the content profiles to create a first set of content options;
organizing the first set of content options into groups wherein said organization is based upon predefined rules;
calculating the revenue generated by the subscriber's purchase of each group of content options; and
offering to the subscriber at least one content choice group in the form of a content package for purchase wherein the content package, if purchased by the subscriber, generates substantially more revenue for a content distributor relative to other content option groups.

17. The method of claim 16 further comprising the steps of:
registering a request made by the subscriber;
scheduling the delivery of content requested by the subscriber, wherein the content distributor is able to insert at least one promotional campaign before, after, or during the delivery of the requested content; and
delivering the requested content with the at least one promotional campaign to the subscriber.
